(19) United States
(12) Patent Application Publication
(10) Pub. No.: US 2025/0361177 A1
(43) Pub. Date: Nov. 27, 2025

(54) Method For Making Sputtered Metallic Thin Film

(71) Applicant: Board of Trustees of Michigan State University, East Lansing, MI (US)

(72) Inventors: Qi Hua FAN, Okemos, MI (US); Thanh TRAN, East Lansing, MI (US)

(73) Assignee: Board of Trustees of Michigan State University, East Lansing, MI (US)

(21) Appl. No.: 19/210,013

(22) Filed: May 16, 2025

Related U.S. Application Data
(60) Provisional application No. 63/650,524, filed on May 22, 2024.

(51) Int. Cl. C03C 17/36; G02B 5/28

(52) U.S. Cl. CPC C03C 17/366; C03C 17/3644; C03C 17/3649; G02B 5/282; C03C 2217/211; C03C 2217/231; C03C 2217/252; C03C 2217/256; C03C 2217/948; C03C 2218/156

(57) ABSTRACT

A method for making sputtered metallic thin film is provided. In another aspect, a method emits ions from an ion source and sputters a metal material with a magnetron to deposit an ultra-thin silver film on a workpiece substrate, with the film having a thickness of less than 9 nm. Another method of coating a workpiece substrate includes sputter deposition of an initial or seed layer of silver, having a thickness of 6 nm or less, and ion treating the initial silver layer from an ion source during the sputtering. A further aspect deposits at least one silver layer on a transparent substrate, and an aluminum cap on the silver layer(s).

### CROSS-REFERENCE TO PRIOR APPLICATION

The present application claims priority to U.S. provisional patent application No. 63/650,524, filed on May 22, 2024; which is incorporated by reference herein.

### GOVERNMENT RIGHTS

This invention was made with government support under 1917577 awarded by the National Science Foundation. The government has certain rights in the invention.

### BACKGROUND AND SUMMARY

Traditional silver (Ag) thin films have wide-ranging applications in optical coatings and optoelectronic devices. However, their poor wettability to glass undesirably leads to an island growth, known as the Volmer-Weber mode, as is discussed in Zhang, C., et al., “High-Performance Doped Silver Films: Overcoming Fundamental Material Limits for Nanophotonic Applications,” Advanced Materials, p. 1605177 (March 2017). As a result, the initial growth stage of conventional silver thin films follows the Volmer-Weber mode characterized by the formation of non-continuous islands with micro-voids. The micro-porous silver films have poor adhesion to the substrate and are easily delaminated in ambient air or at elevated temperatures, especially with the presence of reactive gases. The Zhang publication attempts to overcome these traditional problems by using an aluminum-doped silver material. Furthermore, Zhang teaches away from using indium tin oxide (ITO) since ITO “suffers from issues, such as limited conductivity over large areas, scarcity of the indium element, and toxicity.”

Various methods have been studied to enhance the wettability of silver to substrates and grow ultra-thin continuous and dense silver films. However, using a wetting layer disadvantageously requires additional processing steps and the added layer usually reduces the film transmittance. Furthermore, there is a large variation in the electric conductivity of the silver films due to the effectiveness of different wetting layers, and silver alloys generally result in increased resistivity due to reduced electron mobility.

Moreover, ultra-thin silver films are susceptible to ambient environments and form grayish layers due to oxidation and other chemical reactions. Hence, ultra-thin silver films have poor thermal stability, especially at elevated temperatures. One known attempt added 4 at % of aluminum to a 15 nm thick silver film to enhance its stability. However, forming an alloy typically introduces defects and increases the scattering of charge carriers, leading to reduced electric conductivity. Other known experiments deposited a 2-5 nm thick aluminum layer on top of a 150 nm thick silver film, but this aluminum layer is too thick for applications that require high transmittance. Another experiment applied 2 nm of Al₂O₃ and 1.5 nm of MgO onto a silver film, however, these non-conductive oxides are not suitable for transparent conductive electrodes.

In accordance with the present invention, a method for making sputtered metallic thin films is provided. In another aspect, a method emits ions from an ion source and sputters a metal material with a magnetron to deposit an ultra-thin silver film on a workpiece substrate, with the film having a thickness of less than 15 nm, and more preferably 5-10 nm. Another method of in-line large-area coating includes sputtering deposition of an initial or seed layer of silver, having a thickness of less than 6 nm, and ion treating only the initial silver layer from an ion source during the sputtering.

In another aspect, a method of sputter coating a workpiece substrate includes simultaneously depositing aluminum with silver to create a uniform silver-aluminum alloy on the substrate. A further aspect employs a method of sputter coating a workpiece substrate including depositing less than 1 nm of aluminum on top of a silver film to enhance stability of the silver film. Yet another method of sputter coating a workpiece substrate includes creating a silver layer on a substrate and thereafter sputter depositing aluminum islands on the silver layer, with the aluminum having a 0.1-1 nm average or nominal thickness. A method sputter deposits an ion beam treated silver layer directly on a substrate, then sputter deposits a thicker second silver layer on the first layer, and thereafter sputter deposits a third aluminum cap or outer layer on the second silver layer.

A method sputter deposits an ion beam treated oxide layer directly on a substrate, then sputter deposits a thicker second silver layer on the first layer, and thereafter sputter deposits a third oxide cap or outer layer on the second silver layer. The first oxide layer is preferably one of the following exemplary metals: TiO₂, ITO, AZO or SnO₂. The third oxide layer is preferably one of the following exemplary metals: AZO, SnO₂ or ITO.

A method sputter deposits an ITO layer directly on a PET or CPI polymeric substrate, then sputter deposits a second ion beam treated silver layer on the first layer, and thereafter sputter deposits a third ITO outer layer on the second layer. A method sputter deposits a ZnO layer directly on a PET polymeric substrate, then sputter deposits a second ion beam treated silver layer on the first layer, and thereafter sputter deposits a third ZnO outer layer on the second layer. A method sputter deposits an AZO layer directly on a quartz substrate, then sputter deposits a second ion beam treated silver layer on the first layer, and thereafter sputter deposits a third ITO outer layer on the second layer.

A method sputter deposits a first ITO layer on a glass substrate, a second ion beam treated silver layer on the first layer, a third silver layer on the second layer, a fourth aluminum layer on the third layer, and a fifth ITO layer on the fourth layer, all of the layers being sputtered.

A method of coating a transparent substrate includes: first, emitting ions of <60 eV energy from an ion source while sputtering a silver target material with a magnetron, to deposit a ≤6 nm average thickness initial or seed silver film on the substrate; thereafter, second, sputtering a second layer of silver or aluminum target material deposited upon the initial layer with an average thickness of 6-15 nm, with ion emissions from the ion source in one configuration, and without ion emissions from the ion source in a second configuration. In an optional construction, the ion source emits ions to a narrower area of the layer(s) than is simultaneously or subsequently sputtered by one magnetron, or alternately, multiple magnetrons spaced apart in a direction of movement of the substrate. The ion emission may be on only the initial layer and/or also on the subsequent layer(s).

Another embodiment of the present method includes co-sputtering silver and aluminum within the same vacuum chamber to create a mixed metal layer directly on a transparent substrate, while an ion source emits ions on the mixed metal layer. Still another embodiment of the present method includes sputter depositing and layering chromium or molybdenum directly upon a substrate, with a first portion of the layer receiving ion emissions from an ion source but a subsequent second portion of the layer not receiving the ion emissions. The exemplary ion bombarded, molybdenum coated substrate is well suited for use in making piezoelectric films or for lubricant films, where the layer preferably has a thickness of 2-20 nm. Subsequent vacuum chamber and/or air annealing may be employed for any of the embodiments herein.

The present method preferably employs at least one of the following exemplary sputter target metal materials for the second, third and/or additional layers: Ag, ITO, TiO₂, AZO, SnO₂, or alloys based thereof where they are the majority material (more preferably at least 99%). The present method preferably employs one of the following exemplary workpiece substrates: glass, PET polymer, Quartz or CPI polymer.

The present method advantageously achieves reduced resistivity and high optical transmittance, as compared to traditional methods. The present method further beneficially obtains greatly enhanced film wettability which enhances growth of oriented crystals in the layer(s). Additional advantages and features of the present method and system will become apparent from the following description, claims and figures.

### BRIEF DESCRIPTION OF DRAWINGS

FIG. 1 is an exploded perspective view showing an embodiment of the present thin film panel assembly;

FIG. 2 is a diagrammatic view showing an inline coating system employed to manufacture the present thin film panel assembly;

FIG. 3 is a diagrammatic view showing a magnetron employed in a coating system used to manufacture the present thin film panel assembly;

FIG. 4 is a group of SEM images of the present thin film panel assembly, with an ion beam (“IS”) treated intermediate layer for the left column, and without ion beam treatment for the right column;

FIG. 5 is a group of SEM images of the present thin film panel assembly, with an ion beam (“IS”) treated intermediate layer for the left column, and without ion beam treatment for the right column;

FIG. 6 is a graph showing transmittance spectra of silver thin films deposited by magnetron sputtering;

FIG. 7A is a graph showing transmittance spectra of silver thin films sputtering deposited with ion beam treatment;

FIG. 7B is a graph showing simulated transmittance spectra of continuous silver thin films based on experimental refractive index from Johnson and Christy bulk silver results;

FIG. 8 is a graph showing XRD patterns of silver thin films of 9 nm total thickness with and without ion beam (“IB”) treatment;

FIG. 9A is a graph showing reflectance (“R”), transmittance (“T”) and their sum of a continuous silver thin film with ion beam pretreatment and an aluminum cap layer;

FIG. 9B is a graph showing a comparison of deposited and simulated transmittances of films;

FIG. 10 is a graph showing resistivity of silver thin films produced with and without ion beam (“IB”) treatment;

FIG. 11 is a graph showing magnetron power and deposition rates correlation of silver deposition;

FIG. 12 is a graph showing the influence of ion beam pretreatment time to resistivity of silver films;

FIG. 13 is a graph showing the influence of ion beam pretreatment time to optical properties of silver films;

FIG. 14 is a graph showing transmittance (“T”), reflectance (“R”) and their sum of a degraded silver thin film deposited without ion beam pretreatment and the aluminum cap layer;

FIG. 15 is a graph showing transmittances of various embodiments of the present thin film panel assembly;

FIG. 16 is a diagrammatic sideview showing an embodiment of the present thin film panel assembly;

FIG. 17 is an exploded perspective view showing an embodiment of the present thin film panel assembly; and

FIG. 18 is a diagrammatic side view showing an embodiment of the present thin film panel assembly.

### DETAILED DESCRIPTION

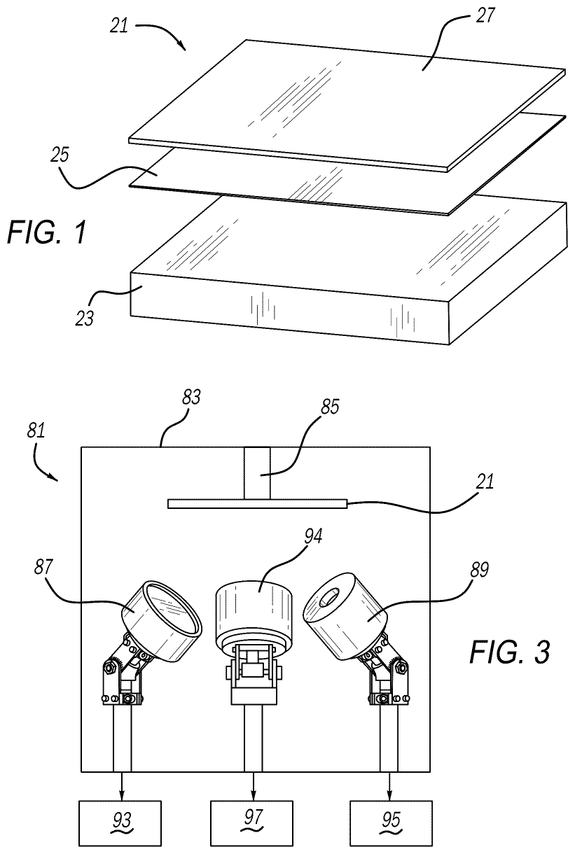

Referring to FIG. 1 a first embodiment of a thin film panel assembly 21 which includes a transparent and flat glass substrate 23, an ion beam-treated silver (Ag) layer 25, and an ion beam-treated aluminum (Al) outer cap layer 27. Silver layer 25 serves as an electrically conductive circuit. In an optional variation thereof, silver layer 25 may include multiple, separately deposited sub-layers including an initial thin silver seed layer directly on substrate 23 and a secondary thicker silver layer deposited on the seed layer; cap layer 27 is thereafter deposited on top of the secondary silver layer.

Another embodiment of a thin film panel assembly 121 is illustrated in FIG. 17. Panel assembly 121 includes a flat glass substrate 123, an inner metal oxide layer 125 having an exemplary thickness less than 100 nm directly deposited on the glass substrate, an ion beam-treated silver layer 127 having an exemplary thickness of 6-7 nm deposited on inner oxide layer 125, and an outer metal oxide layer 129 having an exemplary thickness less than 100 nm deposited on the silver layer. Either of the oxide layers may be one of: TiO₂, ITO, AZO, SnO₂, ZnO, GIO, AZO, magnesium oxide (MGZO), molybdenum (MO), chromium (Cr), or alloys thereof. For example, panel assembly 121 can be a stacked sandwich of the following layers: Glass/TiO₂/Ag/AZO; Glass/ITO/Ag/SnO₂; Glass/ITO/Ag/ITO; Glass/AZO/Ag/SnO₂; Glass/SnO₂/Ag/SnO₂; or Glass/TiO₂/Ag/SnO₂.

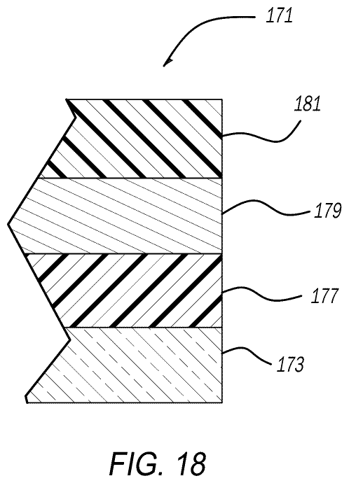

FIG. 17 shows another embodiment of a thin film panel assembly 141 including a flat glass substrate 143, an inner ITO layer 145 directly deposited on the glass substrate, a first ion beam-treated seed silver sub-layer 147 having an exemplary thickness of about 1 nm deposited on the inner ITO layer, a second silver sub-layer 149 thicker than the seed silver sub-layer, an aluminum cap layer 151 of about 0.2 nm thickness, and an outer ITO layer 153 deposited on the cap layer. A further embodiment can be observed in FIG. 18, which shows a thin film panel assembly 171 including a flat glass substrate 173, an inner ITO layer 177 directly deposited on the glass substrate, at least one ion beam-treated silver layer 179 deposited on the inner ITO layer, and an outer ITO layer 153 deposited on the silver layer. Air surrounds the panel assembly 171 during annealing.

The present thin film panel assembly is well suited for use as a low-E glass coated widow, such as in a residence or office building. Low-E coatings reflect infrared light but allow visible light to pass through. Hence, they reflect heat out of the building in the summer and keep heat inside in the winter. The present silver film(s) are desired to be as thin as possible to increase visible light transmission while also being stable. As will be discussed in greater detail hereafter, the present sputtering method provides a thin and continuous silver layer while avoiding the conventionally thick silver film and oxidization problems thereof. More specifically, the present ultra-thin continuous silver film layer with a thickness of less than 9 nm, is attractive for low-E glass coatings and optoelectronic devices because of the high electrical conductivity, optical transmittance, and plasmonic figure of merit.

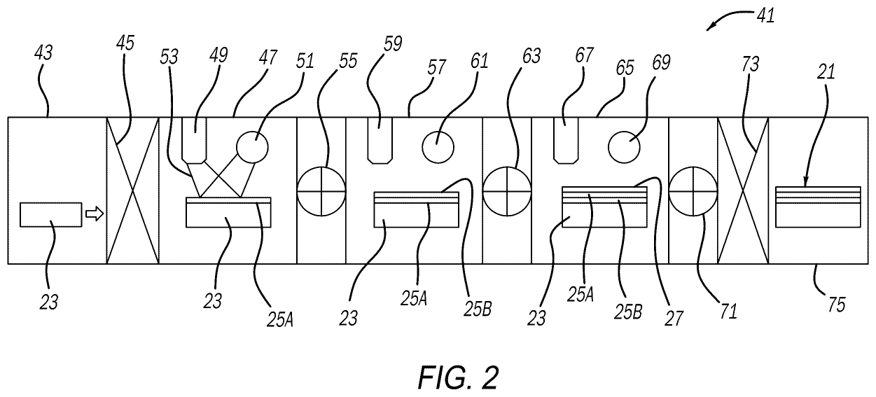

The present manufacturing method utilizes a low-energy ion beam treatment in conjunction with magnetron sputtering to fabricate continuous silver films as thin as 6 nm, by way of nonlimiting example. An inline and high volume, coating magnetron machine 41 is shown in FIG. 2, while a batch coating magnetron machine 81 is shown in FIG. 3. A single-beam ion source, such as 49 in FIG. 2 or 89 in FIG. 3, generates low-energy soft ions (see 53 in FIG. 2) to establish a nominal 1 nm seed silver layer 25A, which significantly enhances the wettability of the subsequently deposited silver films 25B, resulting in a continuous film of approximately 6 nm with a resistivity as low as 11.4 μΩ·cm.

More specifically, inline machine 41 includes a loading chamber or station 43, where flat glass substrate 23 is loaded onto a moving conveyor belt, chain or bed, after which it is automatically linearly moved through a gate valve station 45 and into a first magnetron coating chamber or station 47. A pump 55 creates a vacuum within station 47, and ion source 49 emits ions 53 within a plasma and sputters the first metallic material, here silver from a silver sputter source 51 to sputter deposit seed silver layer 25A in the present example, onto glass substrate 23. Thereafter, the conveyor moves the silver coated substrate into a second magnetron coating chamber or station 57. A pump 63 creates a vacuum within station 57, and another ion source 59 emits ions within a plasma and sputters the second metallic material, here silver from a silver sputter source 61 to sputter deposit a secondary and thicker silver layer 25B in the present example, onto the seed silver layer 25A. Next, the conveyor moves the multiple silver coated substrate into a third magnetron coating chamber or station 65. A pump 71 creates a vacuum within station 65, and yet another ion source 67 emits ions within a plasma and sputters the third metallic material, here aluminum from an aluminum sputter source 69 to sputter deposit a cap aluminum layer 27 in the present example, onto the second silver layer 25B. The conveyor thereafter moves the completed panel assembly 21 through another gate valve station 73 to an unloading chamber or station 75, where it is unloaded and removed from the conveyor. The completed panel assembly 21 is then assembled to a display screen, a building window assembly, a solar panel, or the like. The inline coating machine may be altered to add additional magnetron stations if more layers are deposited, and the sputtering sources may provide different materials depending on the desired layer chemistry desired. Moreover, reactive gas sources and electrical circuits are part of each magnetron station.

The present method and machinery achieve excellent light transmittance and also superior adhesion of the layers to the glass substrate as compared to conventional attempts sputter-depositing silver films without the present ion beam treatment, as will be discussed in greater detail hereinafter. Furthermore, the present ion beam treatment promotes nucleation, while films without the ion beam treatment tend to form isolated islands. X-ray diffraction patterns indicate that the (111) crystallization is suppressed by the soft ion beam treatment, while growth of large crystals with (200) orientation is strengthened.

The soft ions are preferably generated by a single beam ion source that can emit ions with controllable energies below 60 eV. It is notable that emissions of ions with less than 60 eV energy provides superior sputter control and yield than do traditional higher energies. The present soft ion beam treatment grows an initial silver seed layer of about 1 nm thick and with the deposited film layers having a 6-9 nm thickness (excluding the substrate).

In one configuration, the present method emits ions from an ion source and sputters a metal material with a magnetron to deposit an ultra-thin silver film on a workpiece substrate, with the film having a thickness of less than 9 nm, and more preferably 5-9 nm. Another method of in-line coating large-areas of a workpiece substrate includes sputter deposition of an initial or seed layer of silver, having a thickness less than 6 nm, and ion treating only the initial silver layer from an ion source during the sputtering. The present method and panel assembly preferably employs one of the following exemplary workpiece substrates: glass, PET polymer, Quartz or CPI polymer.

### Example 1—Ion Beam Treatment

Experiment: Borosilicate glass was used as the substrates. The substrates were cleaned in an ultrasonic bath using acetone and methanol followed by baking in the air at 100° C. for 30 minutes before the deposition. The sputtering system (such as but not being limited to one obtained from Kurt J. Lesker Company, as model PVD 75 PRO Line) had multiple sputtering magnetrons, each having a shutter for pre-sputtering.

A single beam ion source or gun 89 (such as but not being limited to one obtained from Scion Plasma LLC as model SPR-10) was integrated into the sputtering system so that both ion gun 89 and a silver target magnetron 87 pointed to the substrate 21 center from different directions at an angle of approximately 60 degrees; this can be observed in FIG. 3, but without the optional centrally mounted aluminum target magnetron 94 and DC power supply 97. A DC power supply 95 is connected to ion gun 89 and an RF power supply 93 is connected to silver target magnetron 93. A holder 85 retains substrate 21 within a batch vacuum chamber 83. The ion gun emitted argon ions with an estimated peak energy of 60 eV and a flux density of 1×10²⁰ m⁻²·s⁻¹. A preferred ion source is disclosed in U.S. Pat. No. 11,049,697 entitled “Single Beam Plasma Source” which issued to common co-inventor Fan on Jun. 29, 2021, and U.S. Patent Publication No. 2022/0013324 entitled “Single Beam Plasma Source” which published to common co-inventor Fan on Jan. 13, 2022, both of which are incorporated by reference herein.

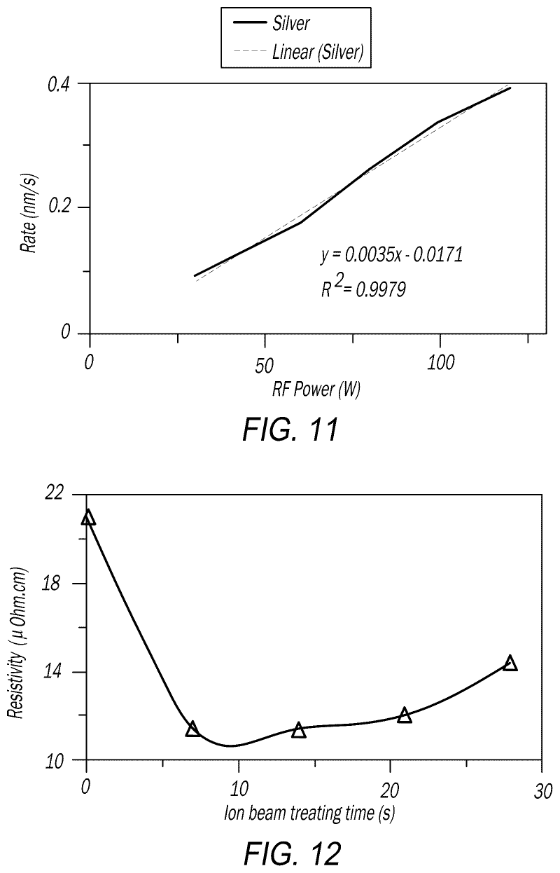

Vacuum chamber 83 was pumped down to 1.3×10⁻⁴ Pa before the deposition. The sputtering gas was ultra-high purity grade Argon (99.999%) and the pressure was 0.4 Pa. RF sputtering was used to have better control over the film thickness, as is illustrated in the graph of FIG. 11 which shows magnetron power and deposition rate correlation of silver deposition. The ion source was excited by a DC voltage of 120 V with a discharge current of 0.8 A. This ion source operated in a low-voltage high-current regime, generating ions with relatively low energies below 60 eV that could restructure silver films without significant sputtering of the deposited film. The substrate holder rotated at a constant speed of 10 rpm during the deposition. All the depositions were conducted at room temperature. A summary of the deposition conditions is described in the following Table 1.

TABLE 1

| | IB | Silver | Silver |
|---|---|---|---|
| | pretreatment | (pure) | (IB -treated) |
| Target | | Silver | Silver |
| | | 99.99% purity | 99.99% purity |
| Target | | 76.2 mm | 76.2 mm |
| diameter | | (3 inches) | (3 inches) |
| Based | 1.3 × | 1.3 × | 1.3 × |
| pressure | 10⁻⁴ Pa | 10⁻⁴ Pa | 10⁻⁴ Pa |
| Processing | 2 Pa | 0.4 Pa | 2 Pa |
| pressure | | | |
| Processing gases | Argon | Argon | Argon |
| | (99.99%) | (99.99%) | (99.99%) |
| Discharge stage | 120 V, 800 mA | 100 W | 10 W |
| Deposition | Room | Room | Room |
| temperature | temperature | temperature | temperature |
| Target | | Silver | Silver |
| | | 99.99% purity | 99.99% purity |
| Deposition | Ion beam | Magnetron | Magnetron |
| technique | pretreatment | sputtering | sputtering |

The film thickness was controlled by the deposition time assuming that the deposition rate was constant under specific process conditions. For each set of process parameters, a rate test was performed first by depositing a film for an extended period of time to achieve a thickness over 100 nm to ensure measurement accuracy. The film thickness was measured using a profilometer. Before deposition, an ink line was marked across the center of a cleaned substrate. After deposition, the ink mark was removed together with the silver film on top using acetone in an ultrasonic bath leaving behind a step profile for the profilometer measurement. Then, the deposition rates were determined from the film thickness and the deposition time.

Optical transmittance was measured using a spectrophotometer. The sheet resistance was characterized in ambient air using a four-point probe sheet resistivity meter having a range of 0-1,000Ω/sqr, resolution of 0.4Ω/sqr, and accuracy of 0.7Ω/sqr at 100Ω/sqr. Furthermore, the morphology of silver films was characterized using a scanning electron microscope. Glancing angle X-Ray diffraction (XRD) was performed at an incident angle of 1° (SmartLab, Rigaku) and the diffractometer used Cu Karadiation having a wavelength of 1.54 Å.

The optical simulation was performed using the transfer matrix method. The refractive indices of silver and glass were taken from Johnson, P. and Christy, R., “Optical constants of the noble metals,” Physical review B, 6 (12), 4370 (1972), and Schott Zemax catalog 2017-01-20b, respectively.

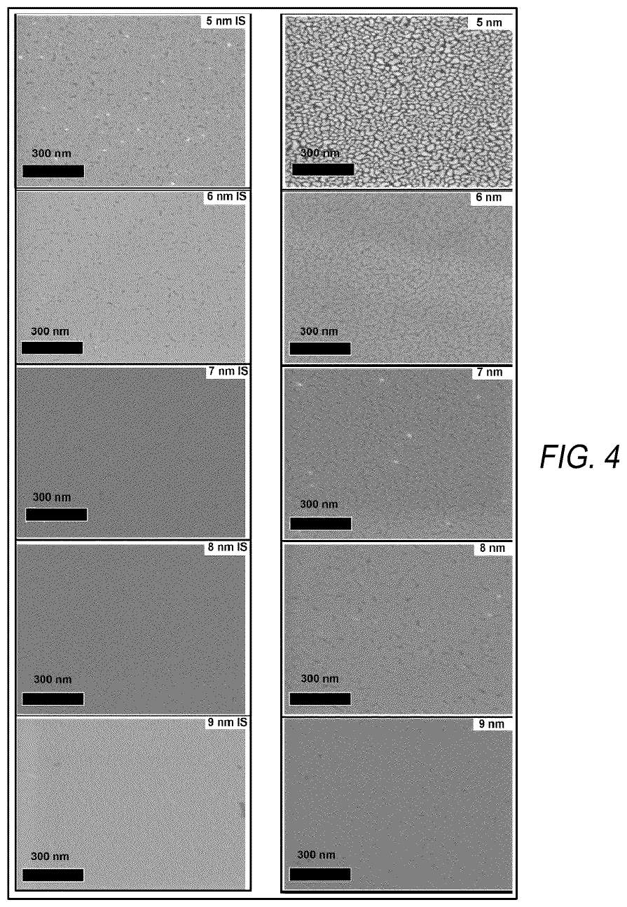

Results: Scanning electron microscopy (SEM) images of the silver thin films of different nominal thicknesses are shown in FIG. 4. Although there are still small voids, the silver film of 5 nm thickness with the ion beam (IB) treatment (first and second images in the left column) is continuous and no isolated islands are observed. This is desirable to achieving high electric conductivity. On the other hand, the silver film of 5 nm and 6 nm thicknesses without the ion beam treatment (first and second images in the right column) have isolated islands, resulting in poor conductivity. These islands become connected once the film reaches 8-9 nm (bottom two images in each column). Hence, the ion beam treatment significantly reduces the percolation threshold for a continuous silver film. The FIG. 4 SEM images are of silver thin films with nominal thicknesses of 5 to 9 nm, with (left column) and without (right column) an IB-treated intermediate layer; the scale bar is 300 nm.

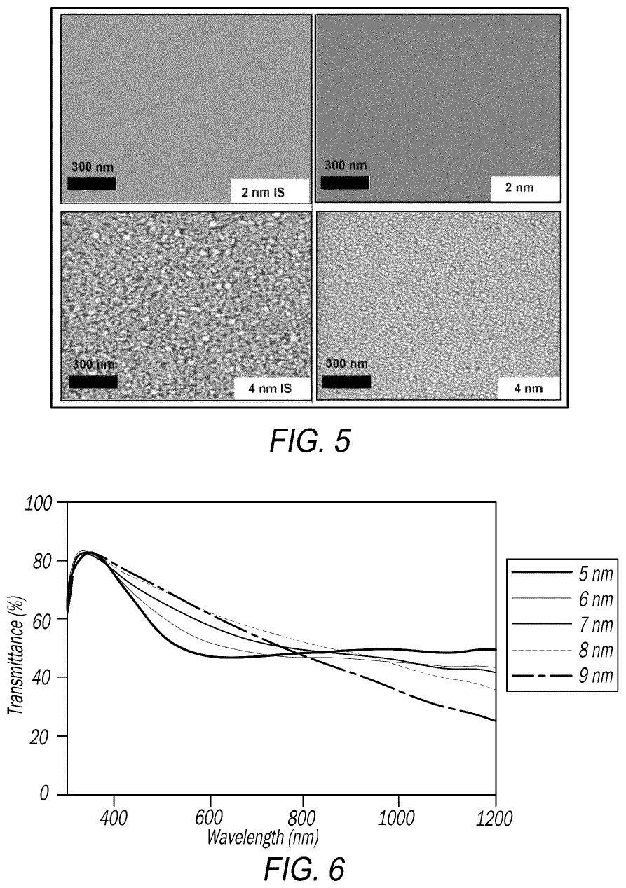

The early growth stage of silver deposited on carbon grids with (left column in FIG. 5) and without (right column in FIG. 5) the ion beam treatment were examined to further investigate the effect of the ion beam treatment. As shown in FIG. 5, silver films thinner than 4 nm (2 nm in top images) are still in islands with and without ion beam treatment. However, there are two distinctions between them. The first one is the island size in the ion beam treated film is bigger and a network between the islands has been formed. The second one is the islands in the ion beam treated film have irregular shapes other than round. These distinctions indicate that the ion beam treated silver has better wettability to the substrate than the untreated one. 4 nm thickness is shown in the bottom images and the scale bar is 300 nm.

The ion beam treatment could have several favorable effects to the growth of silver thin films. One was cleaning the substrate surface, which promoted the film wettability by increasing the substrate surface energy. The other was the ion bombardment that promoted the mobility of the deposited silver atoms and densified the film. It is worth noting that the single beam ion source discharge voltage was only 120 V, which led to a soft beam of ions with average energy below 60 eV. This soft ion-surface interaction can effectively modulate the film microstructure without severe sputtering of the deposited atoms.

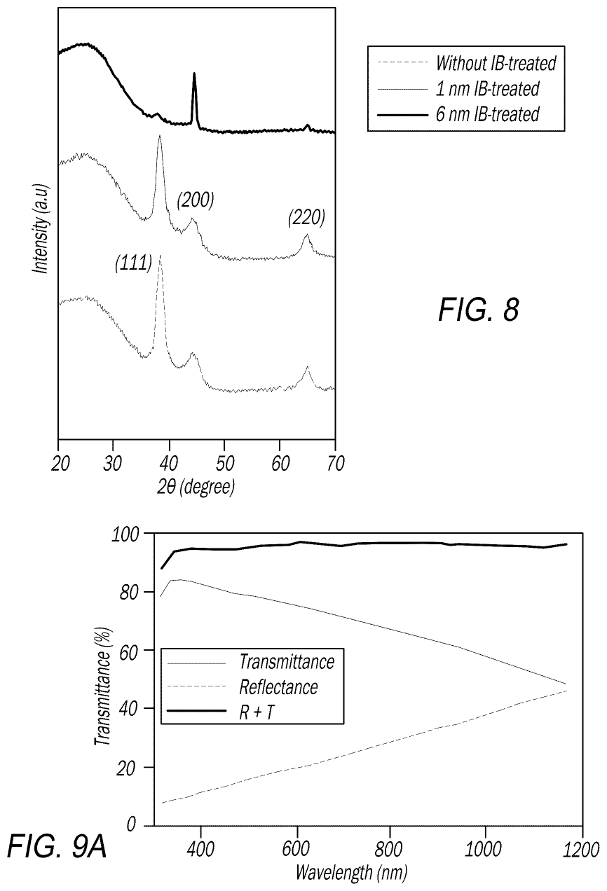

Glancing angle XRD could determine the crystal structures of ultra-thin silver thin films. FIG. 8 illustrates the glance angle XRD patterns of three silver films of 9 nm thickness: untreated silver film, film with 1 nm IB-treated seed layer, and film with 6 nm IB-treated seed layer. The 6 nm IB-treated layer is chosen for exaggerating the effects of ion beam treatment and examining the effects of simple sputtering deposition of the remaining 3 nm atop the treated layer. The XRD pattern of the untreated film shows (111) dominant crystal orientation. On the other hand, IB-treatment suppresses the (111) orientation and enhances the (200) growth as evidenced by the decreased intensity of (111) peak and increased intensity of (200) peak when the thickness of the IB-treated layer increases.

The ion beam treatment not only changes the crystal orientation, but also affects the crystallinity as evidenced by the full width at half maximum (FWHM) of the (200) peak. Scherrer equation is used to calculate the crystal size:

$$𝒯 = \frac{K λ}{β cos θ}$$

where [symbol] is the mean size of the oriented crystal, K is the shape factor and is given the value of 0.9 for all films, λ is the X-ray wavelength of 0.154 nm, β is the full width at half maximum (FWHM) in radians, and θ is the Bragg angle. The crystal sizes of the 9 nm silver films without and with only 1 nm IB-treated seed layer are calculated to be ˜6 nm. The crystal size of the silver film with a 6 nm IB-treated seed layer is calculated to be ˜17 nm, much larger than the film without ion beam treatment. Hence, the ion beam treatment greatly enhanced the lateral growth of the crystals with (200) orientation.

The surface energies of silver (200) and (111) planes are 0.810 and 0.773 J m⁻², respectively. These results imply that (111) orientation would be a preferred growth direction if no additional energy is provided to the deposited atoms. It is likely that the activation energy for silver atoms in (200) plane is higher than in (111) plane. Therefore, the ion beam treatment could provide significant energy to the silver atoms and enhance the growth of (200) orientation even at room temperature. This kind of microstructure modification could hardly be achieved even at elevated substrate temperatures.

An immediate effect of the improved wettability with ion beam treatment was the increased silver film adhesion. This is confirmed by using standard 100-grid tests on 100 nm silver films deposited on glass with and without ion beam treatment. The results show that the silver film with ion beam treatment had nearly no peeling off over the grids, whereas the majority of the grids were removed for the film deposited without ion beam treatment. The borosilicate glass substrate used has typical transmittance and reflectance with negligible absorption in the visible and near-infrared wavelength range. Theoretically, an ultra-thin silver film (e.g., <10 nm thickness) has low absorption. The simulated transmittance and reflectance spectra of silver thin films of different thicknesses from 5 to 9 nm on glass substrates indicate that the thinner the film, the higher the transmittance, in the condition that the film is smooth and continuous. From the transmittance T and reflectance R, the absorptance A can be deduced (A=100−T−R). For a silver film of 6 nm, the absorptance is less than 5% in the visible and near-infrared range. Therefore, an ultra-thin silver film combined with appropriate anti-reflection coatings can be highly transparent.

Although an ultra-thin silver film is desirable to achieve attractive optical and electrical properties, it is challenging to produce continuous silver films of less than 9 nm thickness using conventional physical vapor deposition such as sputtering. FIG. 6 shows the transmittance spectra of silver films of different thicknesses produced by magnetron sputtering. The transmittance of 9 nm thickness silver film has a similar trend as the simulated spectrum. However, the transmittance spectra of the 5-8 nm thickness films deviate from the simulation results and exhibit an obvious dip from 400 to 900 nm, which is due to the known plasmonic effect of non-continuous silver.

The single beam ion source was used to enhance the growth of silver thin films. Only the initial silver layer of approximately 1 nm was treated with the soft ion beam. This seed layer was not necessarily continuous yet. A subsequent silver layer was grown on top of this seed layer by magnetron sputtering without the ion beam treatment and the total film thickness included both layers.

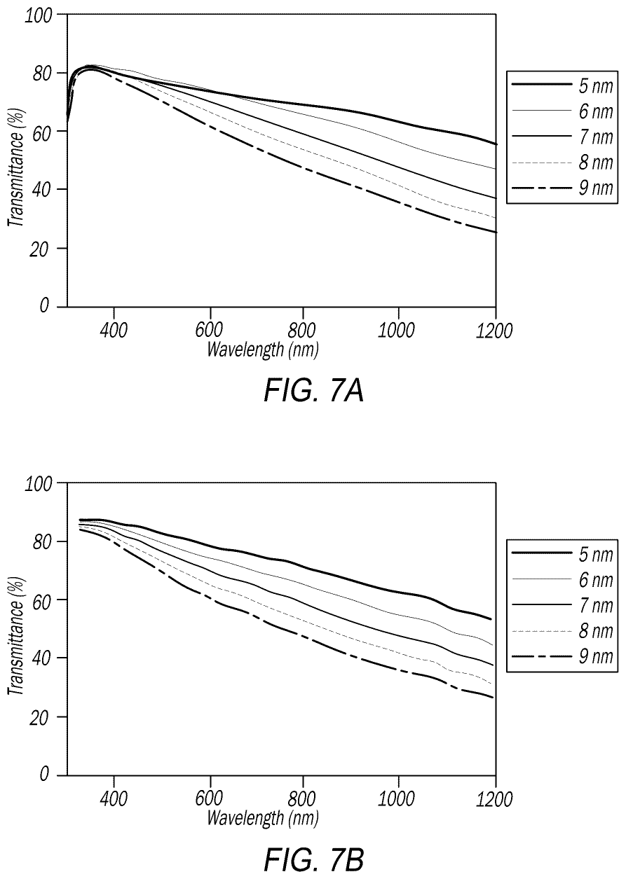

FIG. 7A shows the transmittance spectra of silver films of different thicknesses sputtered atop the 1 nm ion-beam-treated seed layer. Except the film of 5 nm thickness, the transmittance spectra of the other silver films of 6-9 nm thickness followed the same trend as the simulated results shown in FIG. 7B. From SEM characterization, a continuous silver film of ˜6 nm was produced on glass with the assistance of the single beam ion source, whereas a thickness of about 9 nm was required to produce a continuous silver film without the ion beam treated seed layer. This indicates that the discontinuity is the reason for having concave shape in the transmittance spectrum at the wavelength region of 400 nm to 600 nm.

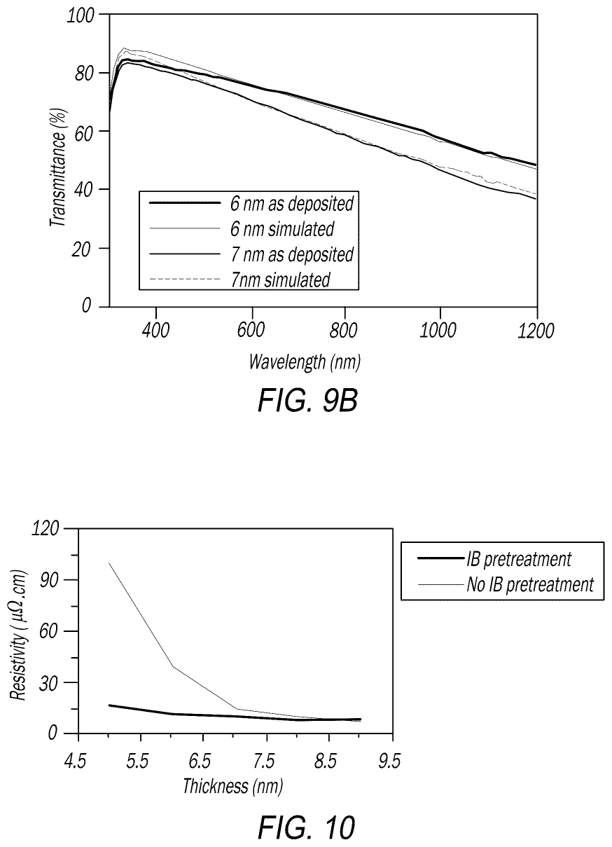

FIG. 9A shows the transmittance T, reflectance R, and T+R in one graph for a 6 nm silver film deposited on glass with the ion beam treated seed layer. The sum of transmittance and reflectance is higher than 95% in visible and the infrared ranges. Therefore, with an appropriate optical design, this ultra-thin silver film could lead to high reflectance in the infrared and high transmittance in visible light ranges, which is particularly attractive for low-E glass coatings. FIG. 9B shows a closer look of the transmittance of 6 nm and 7 nm compared to the simulation results using Johnson and Christy bulk silver refractive index. The spectra are in good agreement in the long wavelength range and slightly off in the short wavelength range, likely due to the scattering caused by the voids. FIGS. 9A and B pertain to a 6 nm continuous silver film deposited with ion beam pretreatment and an aluminum cap layer.

In addition to achieving high transmittance, the ion beam treatment also resulted in significantly reduced resistivity of ultra-thin silver films, as shown in FIG. 10. For example, the ion beam treated silver thin film of 6 nm thickness had a resistivity of ˜11.4 μΩ·cm, corresponding to a sheet resistance of ˜19Ω/sqr, compared to ˜39 μΩ·cm of the untreated silver film of the same thickness. The film resistivity also matches the transmittance spectra presented above, confirming that the ion beam treatment results in continuous silver films.

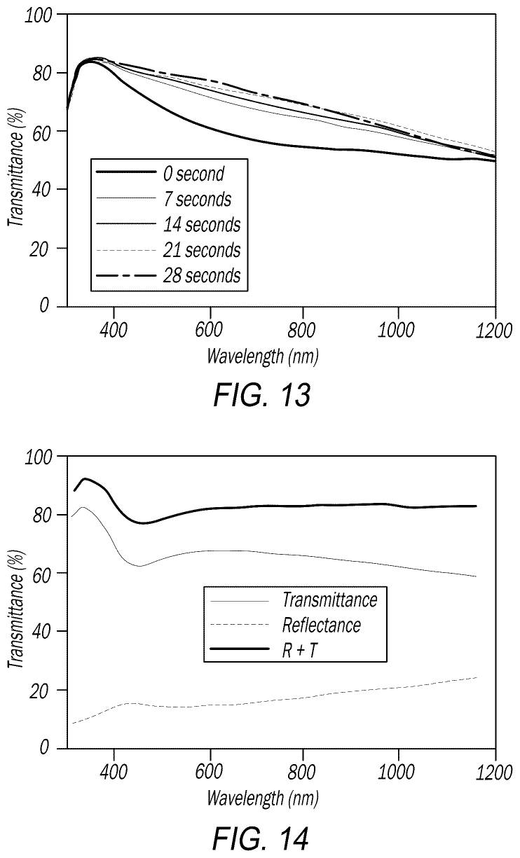

FIG. 12 illustrates the influence of ion beam pretreatment time to resistivity of silver films where 21 seconds correspond to 1 nm of IB treated silver film. Next, FIG. 13 shows the influence of ion beam pretreatment time to optical properties of silver films. Referring now to FIG. 14, Transmittance (T), Reflectance (R), and their sum (R+T) can be observed for a degraded 6 nm silver film deposited without the support of ion beam and silver cap layer. The sum of absorbed and scattered light consequently is 1-(R+T) and supposed to be 20%.

### Example 2—Aluminum Cap

In an optional thin film panel apparatus 21 (see FIG. 1) and method of manufacturing same, an atomic-scale aluminum cap layer 27 is deposited on silver layer(s) 25 to enhance the thermal and environmental stabilities of the previously discussed ultra-thin silver films deposited by sputtering with the assistance of the soft ion beam. The resulted film consists of an ion-beam-treated seed silver layer of ˜1 nm nominal thickness, a subsequent silver layer of ˜6 nm thickness produced by sputtering alone, and an aluminum cap layer of ˜0.2 nm nominal thickness. Although the aluminum cap is only one to two atomic layers and likely non-continuous, it improved the thermal and ambient environmental stability of the ultra-thin silver films (˜7 nm thick) without affecting the film's optical and electrical properties.

The improved environmental stability is attributed to the cathodic protection mechanism and reduced diffusivity of surface atoms. Furthermore, the improved thermal stability is attributed to the reduced mobility of surface atoms in the presence of aluminum atoms. Thermal treatment of the duplex film also improves the film's electrical conductivity and optical transmittance by enhancing its crystallinity. Accordingly, the annealed aluminum/silver duplex structure has exhibited low electric resistivity.

This exemplary embodiment is shown in FIG. 1, and employs the batch equipment of FIG. 3, which additionally includes an aluminum target magnetron/source 94 and its associated DC power supply 97. Such a silver magnetron source 87, aluminum magnetron source 94 and ion source/gun 89 may be employed in a high-volume inline coating machine like that of FIG. 2. This creates an aluminum/silver duplex structure which beneficially achieves excellent thermal and environmental stability without compromising the electric and optical properties of ultra-thin silver films. The notable feature of this duplex structure is that the aluminum deposited on the silver is in the form of atomic cluster islands. This approach is motivated by two assumptions: firstly, that forming aluminum islands on top of a silver film could reduce scattering of the charge carriers compared to adding aluminum into the silver matrix, and secondly, that aluminum has a lower electromotive force than silver and could protect silver from oxidation by forming a galvanic couple.

Experiment: Borosilicate glass substrates was cut into 25×25 mm and cleaned using an ultrasonic bath with acetone and methanol, followed by baking at 100° C. for 30 minutes before deposition. The sputtering system had multiple sputtering magnetrons and each magnetron had a shutter for pre-sputtering. A single beam ion source was integrated into the sputtering system, as was discussed hereinabove.

The vacuum chamber was pumped down to below 1.3×10⁻⁴ Pa before deposition. The sputtering gas was ultra-high purity grade argon (99.999%) at a pressure of 0.4 Pa. Furthermore, the processing parameters for creating a seed layer of silver using the ion beam treatment are summarized in Table 2. The ion source operated at 100 W with a corresponding discharge voltage of 120 V. At the same time, the silver was sputtered at the power of 10 W to deposit the seeding layer of 1 nm thick. Then, conventional sputtering was used to deposit the remaining silver films at a rate of 0.3-0.35 nm s⁻¹ using power in the range of 90-100 W. Aluminum was co-sputtered or deposited on top of silver films using pulsed DC power, with the concentration of aluminum varied by adjusting the power applied to the aluminum target. The deposition rate-power correlations of these films are provided in FIG. 11. The substrate holder rotated at a constant speed of 10 rpm during the deposition and all the depositions were conducted at room temperature.

TABLE 2
Processing conditions

| | IB | Silver | Silver | |
|---|---|---|---|---|
| | pretreatment | (IB -treated) | (pure) | Aluminum |
| Target | | Silver | Silver | Aluminum |
| | | 99.99% purity | 99.99% purity | 99.99% purity |
| Target | | 76.2 mm | 76.2 mm | 76.2 mm |
| diameter | | (3 inches) | (3 inches) | (3 inches) |
| Based | 1.3 × | 1.3 × | 1.3 × | 1.3 × |
| pressure | 10⁻⁴ Pa | 10⁻⁴ Pa | 10⁻⁴ Pa | 10⁻⁴ Pa |
| Processing | 2 Pa | 2 Pa | 0.4 Pa | 0.4 Pa |
| pressure | | | | |
| Processing | Argon | Argon | Argon | Argon |
| gases | (99.99%) | (99.99%) | (99.99%) | (99.99%) |
| Target | | Silver | Silver | Aluminum |
| | | 99.99% purity | 99.99% purity | 99.99% purity |
| Discharge | 100 W | 10 W | 90 W-100 W | 0 W-30 W |
| power | | | | |
| Deposition | Room | Room | Room | Room |
| temperature | temperature | temperature | temperature | temperature |
| Deposition | Ion gun | Magnetron | Magnetron | Magnetron |
| technique | | sputtering | sputtering | sputtering |

TABLE 3
Duplex and alloy silver films specifications. The calculated thicknesses are rounded as in the
experiment, they have the uncertainty of 0.14 nm, corresponding to 2% of the whole thickness.

| | | | Calculated | | Global | | | | Nordheim |
|---|---|---|---|---|---|---|---|---|---|
| | Ag | Al | Al | Calculated | Al | | | | coefficient |
| | power | Power | thickness | thickness | C. | Sheet R | Resistivity | | C |
| Sample | (W) | (W) | (nm) | (nm) | (at %) | (Ω\sq.) | (μΩ. cm) | Condition | (μΩ. cm) |
| 1 | 100 | 0 | 0 | 7 | 0 | 13 | 9.1 | Co- | NA |
| 2 | 99 | 5 | 0.09 | 7 | 1.29 | 14 | 9.8 | deposited | 54.97 |
| 3 | 97 | 10 | 0.21 | 7 | 3 | 16.3 | 11.4 | | 79.04 |
| 4 | 95 | 15 | 0.32 | 7 | 4.73 | 21.5 | 15.1 | | 133.15 |
| 5 | 94 | 20 | 0.44 | 7 | 6.39 | 22.3 | 15.7 | | 110.33 |
| 6 | 100 | 0 | 0 | 7 | 0 | 13 | 9.1 | Deposited | |
| 7 | 99 | 5 | 0.09 | 7 | 1.29 | 14.3 | 10.1 | on top | |
| 8 | 97 | 10 | 0.21 | 7 | 3 | 13.5 | 9.5 | | |
| 9 | 94 | 20 | 0.44 | 7 | 6.39 | 16 | 11.3 | | |
| 10 | 90 | 30 | 0.67 | 7 | 9.81 | 20.5 | 14.4 | | |

To compare the properties of pure silver films with aluminum-silver co-deposited and aluminum/silver duplex films, the total thickness was maintained at ˜7 nm for all samples, including a 1 nm seed layer of silver, deposited using ion beam treatment as previously set forth in Example 1. Films with different atomic percentages of aluminum were fabricated to compare the optical and electrical properties. The aluminum-silver co-depositions were made by simultaneous sputtering of silver and aluminum, and the aluminum atomic concentration was estimated according to the deposition rates. The duplex coatings were made by depositing a silver film on glass substrate, followed by depositing aluminum on top.

The film thickness was controlled by the deposition time, assuming a constant deposition rate under specific process conditions. For each set of process parameters, a rate test was performed first by depositing films for an extended period of time to achieve thicknesses over 100 nm to ensure measurement accuracy. The film thickness was determined by using a profilometer. An ink line was marked across the center of a cleaned substrate. After deposition, the ink mark was removed together with the silver film on top using acetone in an ultrasonic bath leaving behind a step profile for the profilometer measurement. Then, the deposition rates were determined from the film thickness and the deposition time. The error bar for these thickness measurements was within 2%, hence for a 7 nm film, the error bar was interpolated to be 0.14 nm. Normally, the early growth stage has the nucleation process and it takes an incubation time. Therefore, the interpolated thickness for a thinner film is likely the upper bound of the actual thickness.

Optical transmittance was measured using a spectrophotometer and sheet resistance was characterized using a four-point probe sheet resistivity meter, having a measuring range of 0-1,000Ω/sqr, resolution of 0.4Ω/sqr, and accuracy of 0.7Ω/sqr at 100Ω. The morphology of films was characterized using a scanning electron microscope, and X-ray diffraction was performed using Glancing Angle X-Ray Diffraction for thin films at a small incident angle of 2°. The diffractometer uses Cu Karadiation having a wavelength of 1.54 Å. The optical simulation was performed using a transfer matrix method. The refractive indices of silver and glass were taken from Johnson and Christy and SCHOTT Zemax catalog 2017-01-20b, respectively.

Results: All the silver films appeared to be continuous, as no concave feature was observed in the transmittance spectra. The peak transmittance at around 350 nm for the silver-aluminum alloy films slightly decreased as the aluminum concentration increased, but there was no noticeable change in the peak transmittance for the aluminum/silver duplex films.

Notably, the resistivity of the present duplex films was generally lower than that of conventional co-deposited silver-aluminum binary alloy films. When the global atomic aluminum concentration was below 1 percent (at %), the effect of aluminum on film's resistivity was not significant for either type of films. However, the increase in the resistivity was observed for the silver-aluminum binary alloy, which is expected based on Matthiessen's rule. According to this rule, the total resistivity ρₘₐₜᵣᵢₓ of the silver film is:

$${ρ}_{matrix} = {ρ}_{thermal} + {ρ}_{i m p u r i t y} + {ρ}_{deformation} + {ρ}_{surface}$$

Where ρₘₐₜᵣᵢₓ is 9.1 μΩ·cm in this experiment, ρₜₕₑᵣₘₐₗ, ρ_{impurity}, ρ_{deformation} and ρ_{surface} represent the resistivity due to electron scattering by thermal vibration, impurity, defects caused by deformation, and surfaces/interfaces, respectively. When aluminum atoms are introduced into the matrix, they contribute to ρ_{impurity}. Aluminum and silver form a single-phase solid solution when the aluminum atomic concentration is less than 10%. The resistivity of silver-aluminum alloys can be calculated using Nordheim's rule:

$${ρ}_{a l l o y} = {ρ}_{matrix} + C X ( 1 - X )$$

where C is the Nordheim coefficient calculated to be 94 μΩ·cm in average and X is the atomic percentage of aluminum.

The influence of aluminum on the conductivity of bulk silver (1-1.8 μm thick) was found to increase the resistivity by ˜3.5 μm·cm when 3 at. % of Al was added. In co-deposited films, other factors such as surface roughness and stability may have less worse effect on resistivity, particularly ρ_{deformation} and ρ_{surface}, compared to pure silver films as aluminum co-deposited is known to improve these properties. However, the increase in impurity resistivity, ρ_{impurity}, outweighs the changes in deformation and surface resistivity, ρ_{deformation} and ρ_{surface}, resulting in an overall increase in the resistivity of the conventional silver-aluminum alloy film by ˜2.5 μm·cm.

In the case of the present duplex coating, the resistivity is increased due to the reduction in the thickness of silver film. A global aluminum concentration level of 3% resulted in a reasonable increase of 0.4 μΩ·cm, or ˜4%, in resistivity. It is worth noting that, at this atomic concentration, adding aluminum on top of silver did not significantly affect the electrical conductivity of the duplex film compared to the pure silver film. At this global aluminum concentration, the equivalent nominal aluminum thickness was 0.2 nm, and the underlying silver film was 6.8 nm thick, including the IB-treated layer. The 0.2 nm aluminum layer was likely not continuous, as the lattice constant of aluminum is 0.4 nm and it is unlikely magnetron sputtering could form a conformal single layer; therefore, the aluminum layer was expected to be composed of scattered atoms or clusters. Subsequently, global aluminum concentration of 3% were chosen for studying stability of the silver films.

The stability of three types of silver films was compared: a pure silver film, an aluminum/silver duplex coating, and a silver-aluminum alloy. The last two coatings were with a global aluminum concentration of 3%. All the films were approximately 7 nm thick. Considering optical degradation of these films after 120 days, the pure silver film degraded significantly after just two hours of exposure to ambient air at room temperature, while the aluminum/silver duplex coating and the silver-aluminum alloy film both showed less degradation. However, after 60 days, the duplex coating remained largely intact while the alloy film showed some degradation. After 120 days, the duplex film demonstrated negligible degradation, making it the most stable of the three films tested in terms of environmental stability. This suggests that a thin layer of aluminum on top of the silver film can improve the stability of the silver film in the present thin film panel apparatus and method.

The stability of the silver films was further studied by annealing them in vacuum at different temperatures. The transmittance spectra indicate that strong agglomeration occurred in the pure silver film after just one hour of annealing at 100° C. The agglomeration occurred because of the high mobility of surface atoms at high temperature. The high mobility assisted the agglomeration process to form isolated islands to reduce surface energy and made the film non-conductive. Once the agglomeration occurred in the pure silver film, the sheet resistance dramatically increased. Furthermore, the transmittance of the co-deposited and duplex coatings improved slightly after annealing. It is thought that adding aluminum can reduce the mobility of surface silver atoms and slow down silver agglomeration. Alternatively, the bond dissociation energy of Ag—Ag is 162.9 KJ/mol, which is lower than that of Ag—Al at 183.7 KJ/mol. Therefore, aluminum atoms or clusters might act as anchor points for silver atoms and suppress their surface diffusion.

The variations in the sheet resistance of the silver films at different annealing conditions was also considered. Annealing in vacuum resulted in a decrease in the sheet resistance of the duplex aluminum/silver and co-deposited silver-aluminum films, indicating that no further agglomerations occurred in these films. This suggests that aluminum can increase the thermal stability of silver films. Furthermore, vacuum annealing can improve the transmission and conductivity of silver films by removing micro voids and improving the crystallinity of the film, which helps to reduce the carrier-scattering defects. Accordingly, annealing results in better crystallinity for the duplex and co-deposited films and the lowest sheet resistance of 11Ω/sqr, equivalent to 7.7 μm·cm, was obtained for the duplex film annealed in vacuum at 200° C. Additionally, the duplex film does not require additional coatings, such as ZnO or foreign element-based wetting layers, while still exhibiting high thermal and environmental stabilities.

In conclusion, the present method is well suited for protecting sputter-grown ultra-thin silver film by using an extremely thin aluminum cap. The duplex coating consisting of an aluminum cap layer or islands on silver films was found to be superior to co-deposited silver-aluminum binary alloy films in terms of optical transmittance and electrical conductivity. Moreover, it was found that the traditional scattering caused by aluminum impurities was significant and outweighed the slight improvement in continuity, leading to the high resistivity of the co-deposited silver-aluminum alloy film. In terms of environmental stability, the present aluminum cap layer showed high stability compared to other treatments. The stability is thought to be due to the cathodic protection mechanism, in which aluminum is sacrificed to react with oxidants and form transparent compounds, while the silver is protected by its higher standard electromotive forces until aluminum is used up. In terms of thermal stability, pure silver films agglomerated in air and at elevated temperatures during annealing tests. In contrast, the aluminum/silver duplex coatings and co-deposited silver-aluminum alloy films showed excellent thermal stability, as indicated by the reduced resistance, increased transmittance, and improved crystallinity after vacuum annealing. This stability is thought to be due to the reduction of surface atoms diffusivity in the presence of aluminum atoms. Hence, this technology allows for the fabrication of ultra-thin, stable silver films with high transmittance and low sheet resistance. The resulting 6 nm and 7 nm films had good transmittance spectra and low sheet resistances of 15 and 11Ω/sqr, respectively.

These stable, ultra-thin, continuous silver films (6-7 nm) have many potential end-use applications. For example, the present method of applying a cap layer of aluminum could be useful not only for ultra-thin silver film, but also for thicker silver films used in applications such as mirroring and silver-based photography.

### Example 3—Alternate Conductive Oxide Layers

Alternate embodiments of the present thin film panel apparatus and method include additional and optional oxide layers in addition to the thin silver layer(s) and optionally, the aluminum cap layer. Calculated simulations have been made for these configurations wherein the transmittance spectra in the 300-1200 nm wavelength range of six different sandwich structures on glass, comprising typical transparent conductive oxides with an ultra-thin layer of silver at 6 nm and 7 nm in the middle. Further analyses returned contour maps of average optical transmittances in 300-1200 and 400-800 nm wavelength ranges along the thicknesses of the top and bottom oxides in the 0-100 nm range with a step size of 5 nm. The simulation also provides the optimum designs and their corresponding transmittance spectra for each sandwich structure. Among the tested combinations of the present panel assemblies, Glass/TiO₂/Ag/AZO exhibited the highest average transmittance of 90.8% in the 400-800 nm range, while Glass/TiO₂/Ag/SnO₂ demonstrated the highest average transmittance of 83.3% in the 300-1200 nm range. These structures, along with Glass/SnO₂/Ag/SnO₂, are found to have good optical performance and could replace traditional ITO in solar-cell and display applications.

Most transparent conductive oxides have conductivities higher than that of ITO. Using the present sandwich structure with a silver layer in the middle can solve the traditional problem of low conductivity, as the silver layer can be highly conductive and contributes mostly to the conductivity. Additionally, using a conductive and flexible metal layer in the middle can improve an electrode's flexibility.

The other challenge is finding a structure with good transmittance in a desired wavelength range. Often, in conventional sandwich structures, a thick layer of silver is used, which reduces the transmittance of the resulting film, especially in the infrared range, making it unsuitable for applications that require harnessing the light in that range. With the help of an ion beam produced from the single ion source discussed above, the present method is able to deposit ultra-thin and continuous silver films with thicknesses as thin as 6 nm. Accordingly, the sheet resistances of sandwich structures containing 6 nm and 7 nm silver films are expected to be ˜19Ω/sqr and ˜11Ω/sqr, respectively, which is well-suited for incorporation into most optoelectronic end use applications.

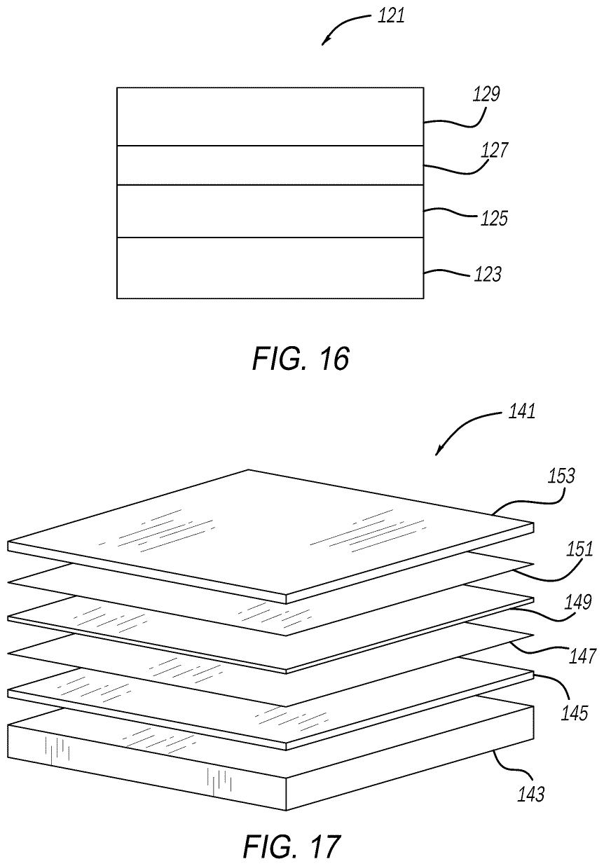

Six different sandwich structures on glass were evaluated which are shown in the following Table 4 with their corresponding names. Graphic illustration of sandwich structure is presented in FIG. 16, where the thin film panel assembly 121 includes a glass substrate 123, a bottom or inner oxide layer 125 with a thickness of 100 nm or less, a silver layer 127 with a thickness of 6-7 nm, and a top or outer oxide layer 129 with a thickness of 100 nm or less.

TABLE 4

| Structure | Name |
|---|---|
| Glass/TiO₂/Ag/AZO | Structure 1 |
| Glass/ITO/Ag/SnO₂ | Structure 2 |
| Glass/ITO/Ag/ITO | Structure 3 |
| Glass/AZO/Ag/SnO₂ | Structure 4 |
| Glass/SnO₂/Ag/SnO₂ | Structure 5 |
| Glass/TiO₂/Ag/SnO₂ | Structure 6 |

In the execution of these nonlimiting experimental examples, all the structure's designs with the top and bottom oxide layers having the thickness scanned in the range of 0-100 nm with a step size of 5 nm are calculated. Two different values are used to evaluate the optical performance of a structure: average transmittance in the 300-1200 nm range (T_{avg-300-1200}) and average transmittance in the 400-800 nm range (T_{avg-400-800}). In practice, different specific values may apply for specific applications. For example, to be used in different solar cells, different wavelength ranges should be applied, and also the weight of transmittance at a certain wavelength should be calibrated according to the photon intensity of the solar radiation spectrum at that wavelength. After having the values calculated, the relationship between these values and the thicknesses of the top and bottom oxides layers are plotted in contour maps for each thickness of silver and each structure. Also, the optimum designs for each structure are extracted together with the transmittance spectrum.

Structure 1 includes a top oxide layer of aluminum-doped zinc oxide (AZO) and a bottom oxide layer of titanium dioxide (TiO₂). AZO exhibits higher transmittance than ITO, making the AZO sandwich structure better in terms of optical performance. According to simulation results, the maximum T_{avg-300-1200} is 82.1% when the silver film thickness is 6 nm, TiO₂ thickness is 35 nm, and AZO thickness is 55 nm. Even at a wavelength of 1200 nm, the transmittance of the structure can still reach 70%. The maximum T_{avg-400-800} is 90.8 when the silver film thickness is 7 nm, TiO₂ thickness is 40 nm, and AZO thickness is 55 nm.

Structure 2 includes a top oxide layer of tin oxide (SnO₂) and a bottom oxide layer of ITO. The maximum T_{avg-300-1200} is 80.8% when the silver film is 6 nm thick, ITO is 30 nm thick, and SnO₂ is 50 nm thick. The maximum T_{avg-400-800} is 90.5 when the silver film is 6 nm thick, ITO is 55 nm thick, and SnO₂ is 45 nm thick. The transmittance of this structure drops to around 60% at 1200 nm when the thickness of silver is 6 or 7 nm. The advantage of this structure is that both ITO and SnO₂ are stable in damp heat.

Structure 3 includes a top oxide layer of ITO and a bottom oxide layer of ITO. The maximum T_{avg-300-1200} is 77.2% when the silver film is 6 nm thick, the bottom ITO layer is 30 nm thick, and the top ITO layer is 45 nm thick. The maximum T_{avg-400-800} is 90.0 when the silver film is 6 nm thick, the bottom ITO layer is 55 nm thick, and the top ITO layer is 50 nm thick.

Structure 4 includes a top oxide layer of SnO₂ and a bottom oxide layer of AZO. The maximum T_{avg-300-1200} is 81.3% when the silver film is 6 nm thick, the bottom AZO layer is 35 nm thick, and the top SnO₂ layer is 50 nm thick. The maximum T_{avg-400-800} is 90.6 when the silver film is 6 nm thick, the bottom AZO layer is 60 nm thick, and the top SnO₂ layer is 45 nm thick.

Structure 5 includes a top oxide layer of SnO₂ and a bottom oxide layer of SnO₂, making it highly resistant to damp heat as SnO₂ is the best performer among SnO₂, AZO, and ITO. The maximum T_{avg-300-1200} is 82.2% when the silver film is 6 nm thick, the bottom SnO₂ layer is 40 nm thick, and the top SnO₂ layer, which are relatively high compared to other structures. The transmittance at 1200 nm can be as high as 70% when the thickness of silver layer is 6 nm. The maximum T_{avg-400-800} is 90.2% when the silver film is 6 nm thick, the bottom SnO₂ layer is 55 nm thick, and the top SnO₂ layer is 45 nm thick.

Structure 6 includes a top oxide layer of SnO₂ and a bottom oxide layer of TiO₂, making it suitable for use in damp heat environments as both SnO₂ and TiO₂ perform well in such conditions. The maximum T_{avg-300-1200} is 83.3% when the silver film is 6 nm thick, the bottom TiO₂ layer is 30 nm thick, and the top SnO₂ layer is 50 nm thick. This structure provides good transmittance in both infrared and ultraviolet ranges and therefore has the best T_{avg-300-1200} among other structures discussed in this section. The maximum T_{avg-400-800} is 90.4 when the silver film is 7 nm thick, the bottom TiO₂ layer is 40 nm thick, and the top SnO₂ layer is 55 nm thick.

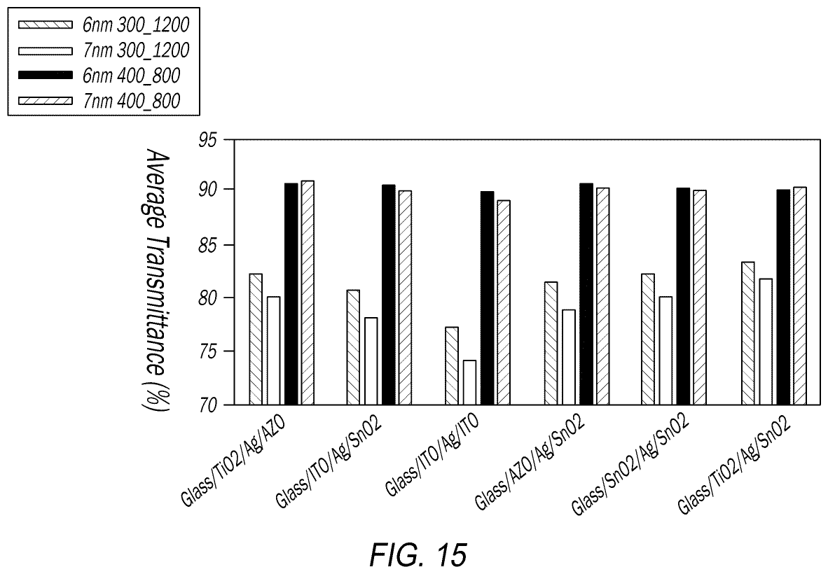

FIG. 15 compares the optimum transmittances of the six structures of the present panel assembly, side-by-side. Most of the structures can achieve similar T_{avg-400-800}, however, Structure 6 provides outstanding T_{avg-300-1200} due to its high performance in the infrared and ultraviolet range of the light spectrum. Thinner silver films result in higher transmittance at the infrared range of the light spectrum for the 300-1200 nm range. On the other hand, for the 400-800 nm range, a 7 nm silver layer in Structures 1 and 6 can result in a higher average transmittance than a 6 nm layer. Among these cases, Structures 5 and 6 are potential choices for high optical performance and stability in a damp heat environment. In actual deposition of oxide films, it is likely that high temperature processing may be needed so that the film's transparency can be high and comparable with simulation result. For example, to obtain transmittance comparable to simulation results, the ITO/Ag/ITO/glass structure uses annealing in air at 200° C. for 1 hour.

### Example 4: ITO-Silver-ITO

Reference should now be made to FIG. 17 which pertains to fabricating highly transparent and conductive electrodes on glass substrates by depositing stable, continuous, and ultra-thin silver films between optimized layers of indium tin oxide (ITO). More specifically in the present exemplary embodiment, a thin film panel assembly 141 includes a glass substrate 143, a bottom or inner ITO layer 145, an ion beam treated seed silver layer 147, a secondary silver layer 149, an aluminum cap layer 151, and a top or outer ITO layer 153.

Exceptional thermal stability is achieved, and annealing at 200° C. in vacuum and air enhances the film's optical and electrical performance. X-ray diffraction analysis confirms improved crystallization, marked with the emergence of a silver (200) peak after annealing in air. The resulting electrodes demonstrate outstanding transparency, conductivity, and thermal stability, making them ideal for architectural glass coatings and optoelectronic applications, such as photovoltaics, and liquid crystal and touchscreen displays.

Traditional indium tin oxide (ITO) is a widely used transparent conductive oxide (TCO) material in various optoelectronic applications. It exhibits excellent transparency across a broad spectrum of light ranging from 300 nm to 1200 nm, along with high electrical conductivity, making it an ideal material for such applications. However, due to its ceramic nature, ITO is inherently brittle, which limits its practicality. To overcome this traditional limitation, the present implementation of a sandwich structure including ITO/silver/ITO (IAI) advantageously enhances the flexibility of the films for use in flexible devices. Moreover, the present use of IAI sandwich structure improves transmittance in the visible wavelength range and enhances electrical conductivity compared to standalone ITO films. Silver, with its low product of reflective index, nxk, is an ideal metal for optical applications. Therefore, the present silver-based sandwich structures can be applied in low-E glasses, touchscreens, solar cells, organic light-emitting diodes (OLEDs), and electrochromic devices.

The present apparatus and manufacturing method make the IAI sandwich structure feasible for commercial use. Firstly, when the silver thickness in the IAI sandwich structure exceeds 9 nm, a significant reduction in transmittance occurs at wavelengths beyond 700 nm. To broaden the working window of the transmittance spectrum required for multiple applications, it becomes necessary to use the presently preferred thinner silver film. The present approach achieves low surface roughness and high surface-covering ratios, making them suitable for use in solar cells. The second challenge pertains to the thermal and environmental stabilities of the silver film. Therefore, the present assembly employing silver layers resists oxidation and corrosion, which improves the optical and electrical performances of the film.

Due to the high stability of these silver films, it is expected that the present sandwich structure will exhibit excellent stability in ambient environments and at high temperatures, while maintaining exceptional optical and electrical properties. The high thermal stability also allows for annealing at elevated temperatures in vacuum and in the air, which is expected to further improve the film's quality.

More specifically, the present embodiment sandwich structure 141 is illustrated in FIG. 17, which includes a borosilicate glass substrate 143 with a thickness of approximately 0.5 mm. Bottom layer 145 is a thickness-optimized ITO layer. The next layer is a 1 nm ion beam-treated silver layer 147, aimed at improving the wettability of the silver film for depositing ultra-thin layers below 9 nm. Non-ion beam sputtering is then used to deposit the silver layer 149 with a thickness of (X-1-0.2) nm, where X represents the overall thickness of the silver layer. Following the silver layer, is aluminum cap layer 151 with a thickness of 0.2 nm serving multiple purposes. It acts as an anode in cathodic protection to protect the silver from oxidation and enhances the thermal stability of the silver film by reducing the mobility of surface atoms. Additionally, the aluminum cap layer protects the silver layer during the deposition of the top ITO layer 153.

During the ITO deposition, oxygen is introduced into the magnetron vacuum chamber, and the aluminum cap layer ensures the stability of the silver film, preventing agglomeration triggered due to high mobility of surface atoms in the appearance of oxygen. The presence of aluminum atoms and clusters restricts the mobility of silver surface atoms and prevents further agglomeration of the silver film. The top layer in the sandwich structure is also a thickness-optimized ITO layer.

Experiment: The borosilicate glass substrate was cut into 1×1 inch-squared pieces (6.45 cm²). The substrate underwent cleaning in acetone and methanol using an ultrasonic bath, followed by baking at 100° C. for 30 minutes before deposition. The sputtering system employed multiple sputtering magnetrons, with each magnetron equipped with a shutter for pre-sputtering to clean the target surface. For depositing the silver intermediate layer, a single beam ion source was integrated into the sputtering system, as depicted hereinabove.

Experiment: The processing parameters for these layers are summarized in the following Table 5. The vacuum chamber was initially pumped down to a base pressure of 1.33E-4 Pa. Ultra-high purity grade (99.999%) argon gas was used as the sputtering gas. The sputtering/processing pressure was maintained at 0.4 Pa for pure silver and aluminum depositions, while it was set at 2 Pa during the ion beam pre-treatment process and 0.67 Pa for ITO deposition. During silver deposition, an RF power of 97 W was applied, resulting in a deposition rate of approximately 0.32 nm/s. Aluminum deposition was conducted at a DC power of 10 W for 18 seconds, resulting in a deposition rate of approximately 0.011 nm/s. For ITO deposition, the same deposition recipe was used for both bottom and top layers. An oxygen percentage of 1.5% was chosen to achieve good transmittance, and the ITO deposition rate was approximately 12 nm/min. The substrate holder rotated at a constant speed of 10 rpm during the deposition process, and all depositions were performed at room temperature.

TABLE 5

| | IB | ITO (bottom | | |
|---|---|---|---|---|
| | pretreatment | and top) | Silver | Aluminum |
| Target | | 97 wt % In₂O₃ + | Silver | Aluminum |
| | | 3 wt % SnO₂ | 99.99% purity | 99.99% purity |
| Target | | 76.2 mm | 76.2 mm | 76.2 mm |
| diameter | | (3 inches) | (3 inches) | (3 inches) |
| Based | 1.3 × | 1.3 × | 1.3 × | 1.3 × |
| pressure | 10⁻⁴ Pa | 10⁻⁴ Pa | 10⁻⁴ Pa | 10⁻⁴ Pa |
| Processing | 2 Pa | 0.67 Pa | 0.4 Pa | 0.4 Pa |
| pressure | | | | |
| Processing | Argon | Argon/O₂ | Argon | Argon |
| gases | (99.99%) | (98.5/1.5) | (99.99%) | (99.99%) |
| Discharge | 100 W | 60 W | 97 W | 10 W |
| power | | | | |
| Deposition | Room | Room | Room | Room |
| temperature | temperature | temperature | temperature | temperature |
| Deposition | Ion beam | Magnetron | Magnetron | Magnetron |
| technique | pretreatment | sputtering | sputtering | sputtering |

The deposition rate and deposition time were parameters used to control the thickness of the films. Optical transmittance measurements were performed using a spectrophotometer. The sheet resistance of the films was characterized using a four-point probe sheet resistivity meter with a range of 0-1000Ω/sqr, a resolution of 0.4Ω/sqr, and an accuracy of 0.7Ω/sqr at 100Ω. Glancing Angle X-Ray Diffraction characterization was carried out using an X-Ray diffractometer with a small incident angle of 2° and Cu Kα radiation (wavelength approximately 1.54 Å).

Global scanning of transmittance was employed to optimize the design of the sandwich structure. The method can optimize the structure for various conditions, including specific wavelength value/range or even across a random profile, such as the solar spectrum (AM 1.5-G). Furthermore, the optimization focused on the average transmittance in the 400-800 nm range (T__{avg 400-800}).

The transmittance of the multi-layer optical structures 171, including the four layers shown in the FIG. 18, was computed using the transfer matrix method. The refractive index values used were obtained from Johnson and Christy for silver, SCHOTT Zemax catalog 2017-01-20b for glass, and König, T., et al., “Electrically Tunable Plasmonic Behavior of Nanocube-Polymer Nanomaterials Induced by a Redox-Active Electrochromic Polymer,” ACS Nano, 8(6), pp. 6182-6192 (2014) for ITO. In the simulation, various thicknesses of silver 179 were considered. A scanning process was conducted over the thickness of the top and bottom ITO layers 181 and 173, respectively, ranging from 0 to 100 nm with a step size of 5 nm, in order to obtain the transmittance data for further analysis. The inner or bottom ITO layer 177 is deposited directly on a glass substrate 173. It is worth noting that in practical applications, to optimize real structures, reflective index of the films is needed to be measured experimentally to be used as inputs for the calculation.

Results: As the silver layer thickness increases, both the overall average transmittance and the optimum average transmittance decrease. For instance, when the silver layer thickness is 6 nm, the optimal T_{avg 400-800} reaches 90.05%. However, when the silver layer thickness increases to 14 nm, the corresponding transmittance drops to only 76.69%. Moreover, the optimal design consists of a bottom ITO layer with a thickness of approximately 50 nm and a top ITO layer with a thickness of around 45 nm. Additionally, it is observed that as the thickness of the silver layer increases, the transmittance decreases more rapidly in the longer wavelength region.

Guided from the simulation results, real IAI sandwich structures were fabricated using the configuration ITO (45 nm)/Ag (X nm)/ITO (50 nm)/glass, where X represents the thickness of silver layer (chosen as 6, 7, 8, and 9 nm). XRD patterns of an ITO (45 nm)/Ag (6 nm)/ITO (50 nm)/glass structure in three different scenarios are considered: as-deposited, annealed in vacuum at 200° C., and annealed in air at 200° C. for 1 hour. The as-deposited film exhibited poor crystallinity in the ITO layers with a dominant crystal orientation of (400). In the sample annealed in vacuum at 200° C., the crystallinity of ITO layers improved, while the dominant orientation remained (400). In the sample annealed in air at 200° C., the film's crystallinity of layers was further enhanced, comparable to the vacuum annealing. However, a significant difference in crystal orientation was observed. The dominant crystal orientation shifted from (400) to (222).

Notably, in the air-annealed sample, a strong peak of Ag (200) was observed, indicating the presence of highly crystallized silver ultra-thin layers oriented in the (200) direction. The introduction of oxygen significantly affected the mobility of silver atoms, leading to the formation of highly crystalized films. In conventional silver deposition process, the preferred growing orientation of (111) is influenced by surface energy. However, in the sandwich structure, as there are no free silver film surfaces, the crystal orientation of the annealed silver film is determined by its interaction with the ITO surface. This approach allows for the preparation of a (100) oriented silver layer tailored for specific applications. For example, (100) oriented silver exhibits improved wettability towards substrate, enabling the formation thinner silver films.

Using the Scherrer equation,

$$𝒯 = \frac{K λ}{β cos θ} ,$$

where [symbol] is the mean size of the oriented crystal, K is the shape factor (0.9 in this study), λ is the X-ray wavelength (0.154 nm), β is the full width at half maximum (FWHM) in radians, and θ is the Bragg angle, the crystal sizes of the ITO films were calculated to be 20 nm. Similarly, the crystal sizes of silver films were found to be the same as the ITO crystals, measuring 20 nm. This consistent value was observed for structures with silver thicknesses of 7, 8, and 9 nm. A naturally grown silver layer exhibits a crystal size of approximately 6 nm, both with and without an ion beam-treated intermediate layer.

A lower transmittance was observed in the short wavelength range for the present sandwich structures with varying thicknesses of the silver layer. Consequently, the average transmittance of the as-deposited films was relatively low compared to the annealed samples. This outcome was expected since the depositions were conducted at room temperature. Thus, at room temperature, the transmittance of ITO is lower than that predicted by the simulation, particularly in the short wavelength region.

After annealing, the transmittance notably increased, particularly when annealed in air at 200° C. The transmittance improved in both the long and short wavelength ranges, resulting from enhancements in the transmittance of both the ITO and silver layer, which is due to the enhancing of crystallinity. The maximum transmittance reached 91.5% at a wavelength of 500 nm and the maximum average transmittance was 89.4%, equivalent to 96% relatively to glass substrate, when the thickness of silver was 7 nm.

The enhancement of transmittance spectra is accompanied by an improvement in electrical conductivity. After annealing in vacuum at 200° C., the sheet resistances of the stacks improved due to the enhanced crystallinity of the silver layer. This finding aligns with the annealing results of standalone silver films. Accordingly, annealing in air further improved crystallinity of silver layer and consequently the sheet resistance of the sandwich structures.

The mean free path of electrons in silver is 53.3 nm. Therefore, when the crystal size is small, grain boundaries have a significant impact on electron scattering. Increasing the crystal size reduces electron scattering at boundaries and greatly enhances electrical conductivity. As a result, a further decrease occurs in the sheet resistance of the sandwich structures after annealing in air at 200° C. for 1 hour.

As the thickness of the silver film increases, the Haccke Figure of Merit (FoM) also increases due to the lower sheet resistance outweighing the decreasing of transmittance. The highest FoM achieved was 77×10⁻³Ω⁻¹ at the silver thickness of 9 nm. Further increases in the thickness of the silver layer are likely to yield even higher FoM values. In the calculation, the transmittance used is the average transmittance in the 400-800 nm range and it is relative to the corresponding substrates. The results indicate that the present sandwich structure exhibits outstanding FoM values which is attributed to the optimization process, ultra-thin silver deposition technique, and the impact of annealing on the optical and electrical performance of the sandwich structures.

In conclusion, the present highly transparent and conductive ITO/ultra-thin silver/ITO sandwich structure on a glass substrate exhibits superior optical and electric properties through the growth of stable continuous ultra-thin silver films, structural optimization using the transfer matrix method (TMM), and the utilization of high-temperature annealing in air. The resulting 7 nm-silver-thick structure demonstrates an average transmittance of up to 89.4% in the 400-800 nm range, equivalent to 96.0% relative to the glass substrate, and a sheet resistance of ˜10 Ω/sq. These values surpass those of conventional ITO films.

The present ion beam treatment is feasible for depositing ultra-thin silver films (6-7 nm) on ITO surfaces. Both vacuum annealing and annealing in air enhanced optical and electrical properties of the sandwich structure and annealing in air prove to be more effective, particularly in terms of silver film crystallization, which significantly influences the conductivity of the structure. After annealing in air, a distinct silver (200) peak, absent in as-deposited and vacuum-annealed samples, is observed. Overall, the resulted structure is an attractive transparent conductive electrode for various optoelectronic applications, as well as optical coatings such as low-E glass.

While various embodiments have been disclosed hereinabove, it should be appreciated that additional variations may be made. For example, other types of substrates and metal oxide layers may be employed although certain advantages may not be obtained. Alternately, the manufacturing equipment and stations may vary depending on the specific layers and materials being deposited, but some benefits may not be achieved with such variations. It should be further appreciated that any of the structural, functional or method step features of any of the embodiments may be interchanged with any of the other embodiments disclosed herein unless explicitly excluded, but certain advantages of doing such may not be obtained. Moreover, some or all of the method steps may be performed in a different order or combination, and additional step may be added without departing from the presently envisioned embodiments. Accordingly, the examples and embodiments described herein are exemplary and are not intended to be limiting in describing the full scope of apparatus, systems, compositions, materials, and methods of this invention. Such changes, modifications or variations are not to be regarded as a departure from the spirit and scope of the invention.

The invention claimed is:

1. A method for manufacturing a transparent panel, the method comprising:
(a) using at least one magnetron to sputter silver material toward a transparent substrate to create a continuous silver layer with an average thickness of 9 nm or less;
(b) enhancing wettability of the silver layer by treating the silver material with an ion beam during the creation of step (a); and
(c) sputter depositing a metallic cap material onto the silver layer, with a cap layer of the metallic cap material having an average thickness of 1 mm or less.

2. The method of claim 1, wherein the creation of the silver layer includes creating multiple separate silver sub-layers with at least one of the sub-layers treated with the ion beam.

3. The method of claim 1, wherein the sputtering of the silver material deposits the silver layer directly onto the substrate, and the cap material includes aluminum, and the aluminum is not an alloy with the silver material.

4. The method of claim 1, further comprising sputtering an inner oxide layer directly onto the substrate and depositing the silver layer onto the inner oxide layer, the inner oxide layer including one of: TiO₂, ITO, AZO or SnO₂, or alloys thereof.

5. The method of claim 1, further comprising sputtering an inner layer directly onto a substrate and depositing the silver layer onto the inner layer, the inner layer including one of: ZnO, GIO, MGZO, molybdenum, chromium, or alloys thereof.

6. The method of claim 1, wherein the metallic cap material includes one of: AZO, SnO₂, ITO, or alloys thereof.

7. The method of claim 1, further comprising sputtering an ITO material onto at least one of: (a) the substrate, or (b) the silver layer where the ITO material is the cap layer.

8. The method of claim 1, wherein:
the substrate is one of: glass, quartz, PET polymer, or CPI polymer;
creating the panel to be transparent with absorptance of less than 5% of visible and near-infrared light;
depositing the silver layer to have a resistivity of about 11.4 μΩ·cm or less; and
using the layers as a transparent part of: a piezoelectric device, a lubricant film, a solar cell, an electronic display, or an electronic touchscreen.

9. The method of claim 1, wherein the sputtering of the silver material and the ion beam treatment thereof are simultaneously performed by in-line coating of the substrate.

10. The method of claim 1, further comprising sputter coating the silver material and the cap material, which includes aluminum, simultaneously to create duplex silver-aluminum materials on the substrate.

11. The method of claim 1, further comprising depositing the cap material, which includes aluminum, as islands on the silver layer.

12. The method of claim 1, further comprising emitting the ion beam to an area of the silver layer narrower than that sputter coated by the at least one magnetron.

13. A method for manufacturing a transparent panel, the method comprising:
(a) sputtering silver material toward a transparent substrate to create a silver layer with a thickness of 9 nm or less;
(b) treating the silver material with ions emitted from an ion source including magnets and plasma, the ions having less than 60 eV of energy, and the ion source being one of: (i) a DC+AC powered ion source, or (ii) a DC+RF powered ion source; and
(c) sputtering an aluminum layer onto the silver layer.

14. The method of claim 13, wherein the silver sputtering, the ion treating and the aluminum sputtering steps further comprise co-sputtering the silver and the aluminum layers within a same vacuum chamber to create a mixed metal layer directly on the substrate while the ion source emits the ions on the mixed metal layer.

15. The method of claim 13, further comprising air annealing the layers.

16. The method of claim 13, further comprising performing the silver sputtering in a first vacuum chamber containing the ion source and a sputtering source with the silver material, and performing the aluminum sputtering in a second vacuum chamber containing a second ion source and an aluminum sputtering source therein, moving the substrate through at least the first and the second vacuum chambers in an inline manner.

17. The method of claim 13, wherein the silver layer includes multiple separate silver sub-layers, with a first of the sub-layers having a 1 nm or less average thickness.

18. The method of claim 13, wherein:
the silver sputtering deposits the silver layer directly onto the substrate, and the substrate is one of: glass, quartz, PET polymer, or CPI polymer;
the substrate and the layers thereon are transparent with absorptance of less than 5% of visible and near-infrared light; and
the silver layer has a resistivity of about 11.4 μΩ·cm or less.

19. The method of claim 13, further comprising sputtering an inner oxide layer directly onto the substrate and depositing the silver layer onto the inner oxide layer, the inner oxide layer including one of: TiO₂, AZO or SnO₂, or alloys thereof.

20. The method of claim 13, further comprising sputtering an inner layer directly onto a substrate and depositing the silver layer onto the inner layer, the inner layer including one of: ZnO, GIO, MGZO, molybdenum, chromium, or alloys thereof.

21. The method of claim 13, further comprising sputtering an ITO layer onto at least one of: the substrate or the silver layer.

22. A method for manufacturing a transparent panel, the method comprising:
(a) sputtering an inner layer directly onto a transparent substrate, the inner layer including one of: TiO₂, ITO, AZO, SnO₂, ZnO, GIO, MGZO, molybdenum, chromium, or alloys thereof;
(b) sputtering a silver layer onto the inner layer;
(c) emitting ions having less than 60 eV of energy at the silver layer during the sputtering of the silver layer; and
(d) depositing a metallic layer onto the silver layer.

23. The method of claim 22, wherein the silver layer includes multiple separate silver sub-layers, with a first of the sub-layers having a 1 nm or less average thickness.

24. The method of claim 22, wherein the metallic layer includes aluminum, further comprising air annealing the layers.

25. The method of claim 22, wherein the inner layer is an oxide comprising TiO₂ or an alloy thereof.

26. The method of claim 22, wherein the inner layer is an oxide comprising ITO or an alloy thereof, and introducing oxygen into a chamber during deposition of the ITO.

27. The method of claim 22, wherein the inner layer is an oxide comprising AZO or an alloy thereof.

28. The method of claim 22, wherein the inner layer is an oxide comprising SnO₂ or an alloy thereof.

29. The method of claim 22, wherein the inner layer is an oxide comprising one of: ZnO or GIO, or an alloy thereof.

30. The method of claim 22, wherein the inner layer is an oxide comprising MGZO or an alloy thereof.

31. The method of claim 22, wherein the inner layer is an oxide comprising one of: molybdenum, chromium, or an alloy thereof.

32. A thin film panel comprising:
(a) a substantially transparent substrate;
(b) a 5-9 nm average thickness and continuous layer of silver;
(c) a 1 mm or less average thickness layer of an outer cap deposited on the silver layer;
(d) the silver layer being located between the substrate and the outer cap layer;
(e) an aluminum layer deposited on the silver layer
(f) an ITO layer deposited on at least one of: (i) the substrate, with the silver layer deposited on the ITO layer, or (ii) the aluminum layer.

33. The thin film panel of claim 32, wherein the silver layer is deposited on the substrate and the silver layer comprises multiple separately deposited silver layers.

34. The thin film panel of claim 32, further comprising an inner layer deposited on the substrate and the silver layer being deposited on the inner layer, the inner layer including one of: TiO₂, ITO, AZO, SnO₂, ZnO, GIO, AZO, MGZO, molybdenum, chromium, or alloys thereof.

35. The thin film panel of claim 32, wherein the outer cap oxide layer is deposited on the silver layer, and the outer cap oxide layer includes one of: AZO, SnO₂, ITO, or alloys thereof.
